(19) United States
(12) Patent Application Publication
(10) Pub. No.: US 2019/0389428 A1
(43) Pub. Date: Dec. 26, 2019

(54) STORAGE MEDIUM, COMMUNICATION APPARATUS, CONTROL METHOD THEREOF, AND UNLOCK SYSTEM FOR UNLOCKING VEHICLE

(71) Applicant: HONDA MOTOR CO., LTD., Tokyo (JP)

(72) Inventor: Haisong LIU, Wako-shi (JP)

(21) Appl. No.: 16/432,033

(22) Filed: Jun. 5, 2019

(30) Foreign Application Priority Data
Jun. 20, 2018 (JP) 2018-117292

(51) Int. Cl. B60R 25/24; B60R 25/25; G07C 9/00

(52) U.S. Cl. CPC B60R 25/246; G07C 9/00119; B60R 25/25; B60R 25/243

(57) ABSTRACT

A non-transitory computer readable storage medium storing a program for causing a computer to function as following units of a communication apparatus which includes a communication device that communicates with an on-board apparatus installed in a vehicle: an obtaining unit configured to obtain a predetermined operation performed by a user; and a control unit configured to control the communication device to transmit an unlock signal for unlocking a door of the vehicle to the on-board apparatus, wherein when the predetermined operation is obtained before communication between the communication device and the on-board apparatus becomes possible, the control unit causes the communication device to transmit the unlock signal in response to an occurrence in which communication between the communication device and the on-board apparatus has become possible.

### CROSS-REFERENCE TO RELATED APPLICATION

This application claims priority to and the benefit of Japanese Patent Application No. 2018-117292 filed on Jun. 20, 2018, the entire disclosure of which is incorporated herein by reference.

### BACKGROUND OF THE INVENTION

### Field of the Invention

The present invention relates to a storage medium, a communication apparatus, a control method thereof, and an unlock system for unlocking vehicle.

### Description of the Related Art

In recent years, there is a known lock/unlock system that can lock and unlock vehicle doors using a communication apparatus such as a smartphone (Japanese Patent Laid-Open No. 2018-005353). In such a lock/unlock system that uses a communication apparatus such as a smartphone, the communication apparatus receives authentication information for locking or unlocking a vehicle from a server, and transmits a lock or unlock request including the received authentication information to a key unit of the vehicle via wireless communication. When the lock or unlock request is authenticated on the vehicle, vehicle doors are unlocked or locked. Unlocking via a communication apparatus such as a smartphone can make it easy for a plurality of users to use the same vehicle in different time slots.

When unlocking is performed using a communication apparatus such as a smartphone, as a specific application intended for unlocking is used, it is necessary to active this application and operate its GUI near a vehicle; this may involve many operational steps leading to unlocking, and cause a burden.

### SUMMARY OF THE INVENTION

The present disclosure has been made in consideration of the aforementioned issues, and realizes a technique to facilitate operations when unlocking vehicle doors using a communication apparatus.

In order to solve the aforementioned problems, one aspect of the present disclosure provides a non-transitory computer readable storage medium storing a program for causing a computer to function as following units of a communication apparatus which includes a communication device that communicates with an on-board apparatus installed in a vehicle: an obtaining unit configured to obtain a predetermined operation performed by a user; and a control unit configured to control the communication device to transmit an unlock signal for unlocking a door of the vehicle to the on-board apparatus, wherein when the predetermined operation is obtained before communication between the communication device and the on-board apparatus becomes possible, the control unit causes the communication device to transmit the unlock signal in response to an occurrence in which communication between the communication device and the on-board apparatus has become possible.

Another aspect of the present disclosure provides a communication apparatus comprising: a communication unit configured to communicate with an on-board apparatus installed in a vehicle; an obtaining unit configured to obtain a predetermined operation performed by a user; and a control unit configured to control the communication unit to transmit an unlock signal for unlocking a door of the vehicle to the on-board apparatus, wherein when the predetermined operation is obtained before communication between the communication unit and the on-board apparatus becomes possible, the control unit causes the communication unit to transmit the unlock signal in response to an occurrence in which communication between the communication unit and the on-board apparatus has become possible.

Still another aspect of the present disclosure provides a control method of a communication apparatus which includes a communication device that communicates with an on-board apparatus installed in a vehicle, the method comprising: obtaining a predetermined operation performed by a user; and controlling the communication device to transmit an unlock signal for unlocking a door of the vehicle to the on-board apparatus, wherein when the predetermined operation is obtained before communication between the communication device and the on-board apparatus becomes possible, the controlling causes the communication device to transmit the unlock signal in response to an occurrence in which communication between the communication device and the on-board apparatus has become possible.

Yet another aspect of the present disclosure provides an unlock system comprising: a communication apparatus; and an on-board apparatus installed in a vehicle, the communication apparatus including a communication device configured to communicate with the on-board apparatus installed in the vehicle, an obtaining unit configured to obtain a predetermined operation performed by a user, and a control unit configured to control the communication device to transmit an unlock signal for unlocking a door of the vehicle to the on-board apparatus, wherein when the predetermined operation is obtained before communication between the communication device and the on-board apparatus becomes possible, the control unit causes the communication device to transmit the unlock signal in response to an occurrence in which communication between the communication device and the on-board apparatus has become possible, and wherein the on-board apparatus includes an unlock unit configured to unlock the door of the vehicle based on the unlock signal from the communication apparatus.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 shows an exemplary configuration of an unlock system composed of a vehicle and a communication apparatus according to the present invention.

FIG. 2 is a block diagram showing an exemplary functional configuration related to control for unlocking vehicle doors according to a first embodiment.

FIG. 3 is a block diagram showing an exemplary functional configuration of a smartphone which is one example of the communication apparatus according to the first embodiment.

FIG. 4 is a flowchart showing a sequence of operations of unlock reservation processing on the smartphone according to the first embodiment.

FIG. 5 is a flowchart showing a sequence of operations of unlock control processing on the vehicle according to the first embodiment.

FIG. 6 is a flowchart showing a sequence of operations of unlock reservation processing on the smartphone according to a second embodiment.

### DESCRIPTION OF THE EMBODIMENTS

### First Embodiment

The following describes an exemplary embodiment of the present invention in detail with reference to the drawings. Note that the following describes an exemplary case in which one or more doors of a vehicle are unlocked using a smartphone, which is one example of a communication apparatus, and an on-board apparatus 200 installed inside the vehicle. However, the present invention is not limited to this embodiment, and the communication apparatus may be another device that can obtain a user operation and perform wireless communication. Examples of such a device may include a tablet terminal and a wearable terminal in the form of, for example, a wristwatch-typed device. Furthermore, the present embodiment is not limited to being applied to unlocking of vehicle doors, but is also applicable to unlocking of a trunk.

<Configuration of Unlock System>

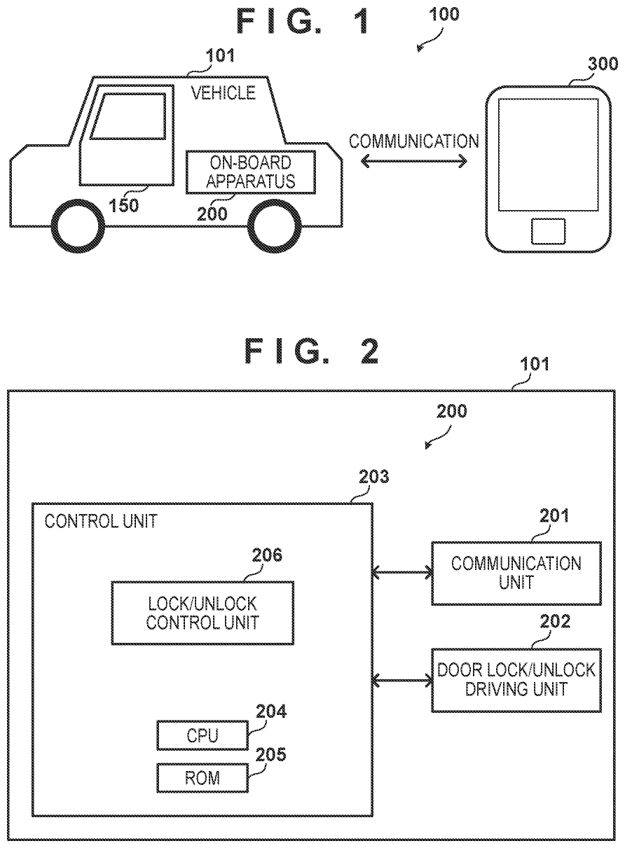

An unlock system 100 according to the present embodiment will now be described with reference to FIG. 1. The unlock system 100 is composed of a vehicle 101 which is, for example, a passenger car or the like, and a smartphone 300. The vehicle 101 has one or more doors 150, and unlocking of the doors 150 can be controlled by the on-board apparatus 200. The on-board apparatus 200 and the smartphone 300 can exchange a command for unlocking and necessary data by establishing wireless communication with a narrow communication range using, for example, BLE (Bluetooth® Low Energy) or the like.

<Configuration Related to Control for Unlocking Doors on Vehicle>

Next, a description is given of a configuration related control for unlocking doors on the vehicle 101 with reference to FIG. 2. The on-board apparatus 200 installed inside the vehicle includes a communication unit 201, a door lock/unlock driving unit 202, and a control unit 203. Furthermore, the control unit 203 includes a CPU 204, a ROM 205, and a lock/unlock control unit 206.

The communication unit 201 includes a communication device provided with, for example, a communication circuit or the like, and exchanges necessary data by establishing wireless communication conforming to, for example, BLE with an external apparatus. In the present embodiment, the communication unit 201 has paired with the smartphone 300 in advance. The communication unit 201 can (without requiring a user's operation on the smartphone) establish BLE communication with the smartphone 300, with which it has paired in advance, when the smartphone 300 is in a nearby range in which BLE communication can be established.

The door lock/unlock driving unit 202 includes, for example, a motor that locks and unlocks the doors 150, and locks or unlocks the doors 150 in response to an instruction from the control unit 203.

The control unit 203 includes the CPU 204 and the ROM 205, and controls the entirety of operations related to unlocking (or locking) of the doors on the vehicle as the CPU 204 executes programs recorded in the ROM 205, for example. The lock/unlock control unit 206 determines whether to unlock the doors based on data exchanged with the smartphone 300 or the state of communication established with the smartphone 300. The vehicle 101 includes a non-illustrated contact sensor installed on a door knob; the contact sensor detects contact that a user has made with the door knob, and notifies the lock/unlock control unit 206 of the contact. The lock/unlock control unit 206 can cause the door lock/unlock driving unit 202 to unlock the doors at a timing when the user makes contact with the door knob.

<Configuration of Smartphone>

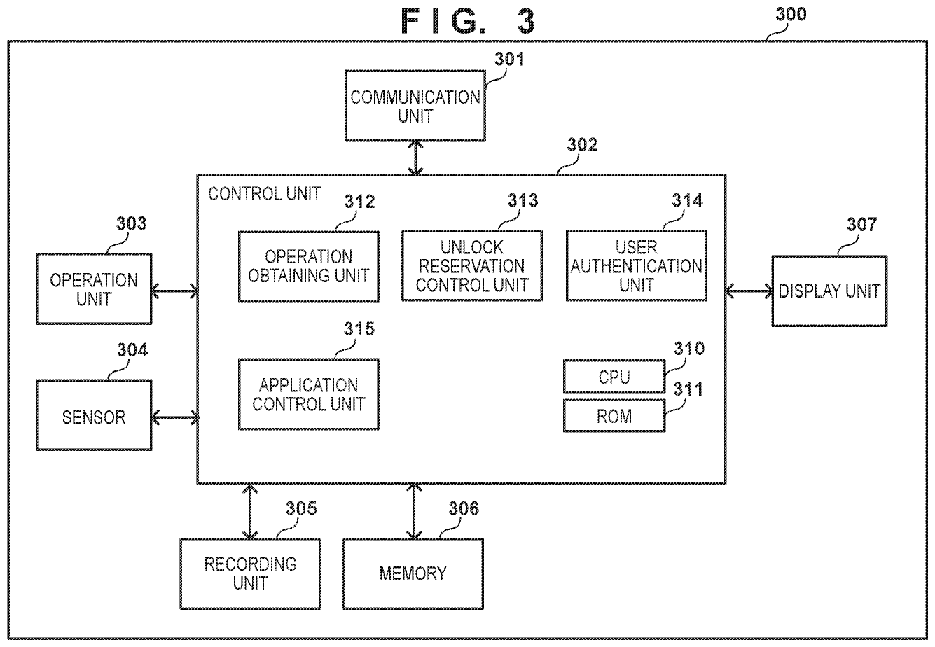

The following further describes a configuration of the smartphone 300 with reference to FIG. 3. A communication unit 301 includes a communication device provided with, for example, a communication circuit or the like, and exchanges necessary data by establishing wireless communication conforming to, for example, BLE with an external apparatus. In the example of the present embodiment, the communication unit 301 has paired with the on-board apparatus 200 in advance. The communication unit 301 can (without requiring a user's operation on the smartphone) establish BLE communication with the on-board apparatus 200, with which it has paired in advance, when the on-board apparatus 200 is in a nearby range in which BLE communication can be established.

A control unit 302 includes a CPU 310 and a ROM 311, and controls overall operations of the smartphone 300 and executes later-described unlock reservation processing as the CPU 310 executes programs recorded in, for example, the ROM 311 or a recording unit 305. The control unit 302 includes an operation obtaining unit 312, an unlock reservation control unit 313, a user authentication unit 314, and an application control unit 315 that are related to the unlock reservation processing according to the present embodiment. The programs executed by the control unit 302 include one or more application programs and programs of an operating system.

An operation unit 303 includes, for example, operation members such as a touchscreen, buttons, and switches, and in accordance with the content of an operation performed by the user, notifies the control unit 302 of information related to the content of the operation. The touchscreen is installed so as to overlap a display screen of a display unit 307, and provides a contact operation with respect to a GUI generated by the application programs or the programs of the operating system.

A sensor 304 includes, for example, an acceleration sensor, a gyroscope, and a GPS, and transmits detected sensor information to the control unit 302. For example, the acceleration sensor measures the acceleration exerted on the smartphone 300 in each of three-dimensional directions, and the gyroscope measures the angular velocity exerted on the smartphone 300. These pieces of measured sensor information are transmitted to the operation obtaining unit 312 of the control unit 302, and used to analyze vibration applied to the smartphone 300 and a change in the orientation of the smartphone 300. Furthermore, the sensor 304 includes a sensor for biometric authentication, and obtains biometric information of the user who is using the smartphone 300. The sensor 304 includes, for example, a camera and a fingerprint sensor. The biometric information obtained by the sensor 304 is transmitted to the user authentication unit 314, and user authentication that uses the biometric information (e.g., face authentication, iris authentication, fingerprint authentication, etc.) is performed.

The recording unit 305 includes, for example, a nonvolatile memory such as a semiconductor memory, and records application programs executed on the smartphone 300, data used by such programs, and the like. A memory 306 is constituted by a volatile memory, and temporarily stores data used by the CPU 310. The display unit 307 is constituted by, for example, an organic EL panel or a liquid crystal panel, and displays a GUI generated by the application programs or the programs of the operating system in response to an instruction from the control unit 302.

The operation obtaining unit 312 obtains a predetermined operation performed by the user using the sensor information from the sensor 304. Examples of the predetermined operation include an operation of applying predetermined vibration, such as the user's shaking of the smartphone 300 several times, or performance of a preregistered gesture while holding the smartphone 300. Furthermore, examples of the predetermined operation may include an operation of changing the orientation of the smartphone 300 in a predetermined manner by turning the tilted smartphone in imitation of the act of turning a key.

The unlock reservation control unit 313 controls the communication unit 301 in accordance with whether the aforementioned user operation has been obtained by the operation obtaining unit 312, and whether the smartphone 300 and the on-board apparatus 200 can perform communication. Under control of the unlock reservation control unit 313, the communication unit 301 transmits a signal that reserves unlocking of the doors 150 of the vehicle 101 to the on-board apparatus 200.

The user authentication unit 314 authenticates whether the user who is currently using the smartphone 300 is a valid user based on information from the operation unit 303 or the sensor 304. When using information from the operation unit 303, for example, the user is authenticated using a passcode input by the user. When using biometric information from the sensor 304, for example, face authentication, iris authentication, fingerprint authentication, or the like is performed. For example, the user is authenticated in accordance with whether biometric information of a preregistered user matches biometric information of the user who is using the smartphone 300. Using the result of authentication performed by the user authentication unit 314, the control unit 302 cancels the locked state of the smartphone 300 and authenticates the user in the unlock reservation processing, for example.

When a plurality of application programs are executed on the smartphone 300, the application control unit 315 controls which application program is to be an active application program. Alternatively, the application control unit 315 controls which application programs is to be activated in accordance with a predetermined trigger. For example, when an unlock reservation application is to be executed, the unlock reservation application is rendered active in response to obtainment of the predetermined operation by the operation obtaining unit 312. At this time, rendering the unlock reservation application active enables the acceptance of a contact operation performed by the user with respect to the unlock reservation application (a touchscreen operation or a fingerprint authentication operation).

<Overview of Unlock Reservation Processing>

The following describes an overview of the unlock reservation processing, in advance to a description of specific operations of the unlock reservation processing according to the present embodiment. To perform conventional unlock processing using a smartphone, a user needs to first approach a vehicle and be in a range in which wireless communication can be established, and then perform a number of operations on a smartphone screen on the spot. Specifically, the user (i) first cancels the locked state of the smartphone, and (ii) on a display screen, selects and activates a specific application that is used to perform unlocking. Then, the user (iii) switches to screen display that enables an unlocking operation on the specific application displayed on the display screen, and (iv) performs an operation of issuing an instruction to perform unlocking on the displayed specific application (e.g., presses a button on the application). Furthermore, the user (v) performs a specific operation intended for authentication because the application requests user authentication. At this time, the smartphone transmits an unlock request to the on-board apparatus, the doors are unlocked, and (vi) the user opens a door by gripping a door handle.

As described above, conventional unlock processing using a smartphone needs to undergo as many as six operations, and requires the operations to be performed while the display screen is visually observed as in (ii) to (iv). Therefore, in performing conventional unlock processing, there is a possibility that a touch operation on the display screen leads to an erroneous operation unless the display screen is gazed at during the operation, and the user has no choice but to operate the smartphone while having the smartphone in front of his/her eyes.

In contrast, in the unlock reservation processing according to the present embodiment, the user can set an unlock reservation before approaching the vehicle. Furthermore, to perform an operation with respect to the unlock reservation application, an operation that can be performed without visually observing the display screen (e.g., shaking the smartphone held in a hand) is used. Therefore, there is no need to perform operations while visually observing the display screen as in conventional (ii) to (iv), thereby facilitating and accelerating operations.

<Sequence of Operations Related to Unlock Reservation Processing>

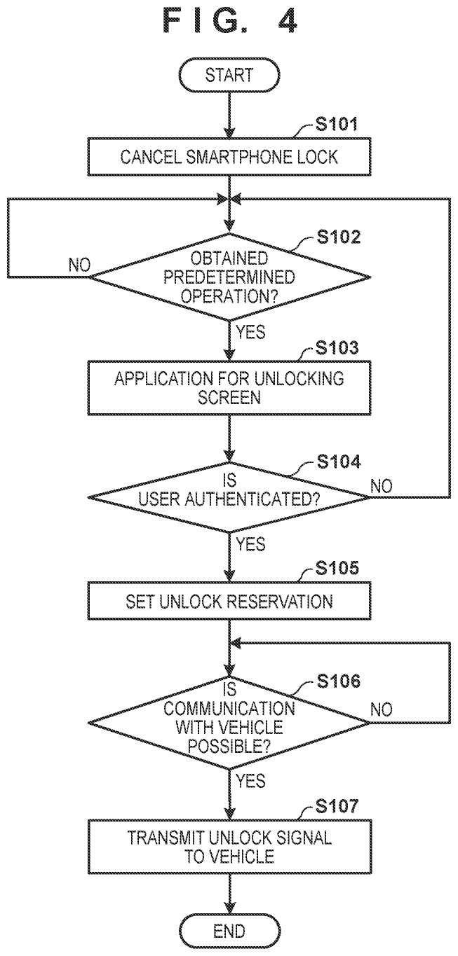

A description is now given of a sequence of operations related to the unlock reservation processing with reference to FIG. 4. Note that the present processing is realized by the CPU 310 of the control unit 302 executing a program stored in the ROM 311 or the recording unit 305. Also note that the present processing is started from a time point when the smartphone 300 is placed in the locked state by the control unit 302. The following description will be given on the assumption that the on-board apparatus 200 and the smartphone 300 have been paired with each other in advance using BLE.

In step S101, the user authentication unit 314 of the control unit 302 authenticates a user and cancels the locked state of the smartphone 300 in response to contact that the user has made with, for example, the fingerprint sensor included in the sensor 304.

In step S102, the operation obtaining unit 312 of the control unit 302 determines whether the user has performed a predetermined operation with respect to the smartphone 300. Examples of the predetermined operation include the user's shaking of the smartphone 300 several times, or an operation of changing the orientation of the smartphone 300 in a predetermined manner, such as turning of the tilted smartphone in imitation of the act of turning a key. For example, when the user has performed an operation of changing the orientation of the smartphone 300 in a manner that imitates the act of turning a key, the operation obtaining unit 312 determines that the predetermined operation has been obtained, and proceeds to step S103. On the other hand, if the operation obtaining unit 312 determines that the predetermined operation has not been obtained, it returns to step S102 again.

In step S103, the application control unit 315 of the control unit 302 displays the unlock reservation application on a display screen. At this time, the application control unit 315 renders the unlock reservation application active and requests user authentication. That is, the application control unit 315 enables the acceptance of a contact operation performed by the user with respect to the unlock reservation application (a contact operation on the touchscreen or the fingerprint sensor).

In step S104, the user authentication unit 314 of the control unit 302 confirms the validity of the user by performing user authentication. If the user authentication unit 314 determines that the user has been authenticated based on information from the sensor 304, it proceeds to step S105; otherwise, it returns to step S102. In step S105, the unlock reservation control unit 313 of the control unit 302 sets an unlock reservation.

In step S106, the unlock reservation control unit 313 of the control unit 302 determines whether communication with the on-board apparatus 200 of the vehicle 101 has become possible based on a notification from the communication unit 301. For example, when the smartphone 300 and the on-board apparatus 200 are in a range in which BLE communication can be established, the communication unit 301 establishes BLE communication and notifies the control unit 302 of the established state of communication. In this case, the unlock reservation control unit 313 determines that communication with the on-board apparatus 200 of the vehicle is possible, and proceeds to step S107. When BLE communication has not been established, the unlock reservation control unit 313 determines that communication with the on-board apparatus 200 of the vehicle is not possible, and returns to step S106.

Upon determining that communication with the on-board apparatus 200 of the vehicle is possible, the unlock reservation control unit 313 of the control unit 302 controls the communication unit 301 to transmit an unlock signal to the on-board apparatus 200 in step S107. Upon completion of transmission of the unlock signal to the on-board apparatus 200, the control unit 302 ends the present processing.

As described above, as an instruction to perform unlocking can be set before communication between the smartphone 300 and the on-board apparatus 200 becomes possible, time required to perform unlocking in the vicinity of the vehicle can be shortened. That is, in bad weather such as heavy rain, boarding can be performed by quickly unlocking the doors. Furthermore, as the necessity to operate the smartphone 300 in front of the eyes is reduced, the burden of operating the smartphone 300 in bad weather or when carrying a large amount of luggage, for example, can be lightened.

<Sequence of Operations of Unlock Control Processing on Vehicle>

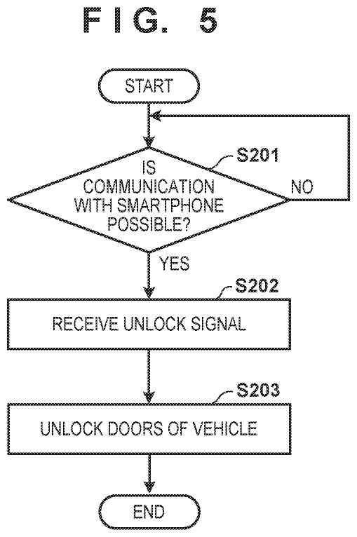

Next, a sequence of operations of unlock control processing on the vehicle will be described with reference to FIG. 5. Note that the present processing is realized by the CPU 204 of the control unit 203 executing a program stored in the ROM 205.

In step S201, the lock/unlock control unit 206 of the control unit 203 determines whether communication with the smartphone 300 has become possible based on a notification from the communication unit 201. For example, when the smartphone 300 and the on-board apparatus 200 are in a range in which BLE communication can be established, the communication unit 201 establishes BLE communication and notifies the control unit 203 of the established state of communication. In this case, the lock/unlock control unit 206 determines that communication with the smartphone 300 is possible, and proceeds to step S202. When BLE communication has not been established, the lock/unlock control unit 206 determines that communication with the smartphone 300 is not possible, and returns to step S201.

At this time, the lock/unlock control unit 206 may authenticate whether the smartphone 300 is a valid smartphone that can make an unlock reservation. For example, as the lock/unlock control unit 206 performs device authentication in accordance with procedures conforming to BLE when establishing BLE communication with the smartphone 300, it may authenticate the smartphone 300 as a valid smartphone upon establishment of BLE communication.

In step S202, the lock/unlock control unit 206 receives an unlock signal from the smartphone 300 via the communication unit 201. Then, in step S203, the lock/unlock control unit 206 unlocks the doors via the lock/unlock driving unit 202. At this time, the lock/unlock control unit 206 may unlock the doors at a timing when, for example, the non-illustrated contact sensor installed on the door knob detects contact that the user has made with the door knob and notifies the lock/unlock control unit 206 of the contact. When the door lock/unlock driving unit 202 has finished unlocking the doors, the control unit 203 ends the present processing.

Note that the above embodiment has described, as an example, a case in which the unlock system is composed of the vehicle 101 and the smartphone 300. However, the smartphone 300 may be configured to communicate with a non-illustrated server and receive information for unlocking the doors of the vehicle 101 (e.g., a virtual key) from the server. In this case, the smartphone 300 may transmit an unlock signal including the virtual key to the on-board apparatus 200, and the on-board apparatus 200 may control the unlocking of the doors 150 using the virtual key received from the smartphone 300.

Furthermore, in a specific case where boarding is performed by unlocking the vehicle doors using the smartphone 300 and then the vehicle doors are locked to leave the vehicle only for a short period of time, a more simplified unlock method may be provided. For example, when the predetermined operation (e.g., shaking of the smartphone) is performed again before a predetermined period elapses since the vehicle 101 was locked, the unlock reservation control unit 313 may not execute user authentication. In this case, an unlock reservation can be set without executing user authentication, and an unlock signal can thereafter be transmitted to the on-board apparatus 200. In this way, the unlock reservation processing can be completed with fewer operations when it is performed within a short period of time since locking was performed.

As described above, in the present embodiment, the control unit 302 obtains a predetermined operation (an operation that can be performed without visually observing a display screen, such as shaking of the smartphone) before communication between the smartphone 300 and the on-board apparatus 200 becomes possible. Then, in response to an occurrence in which communication between the smartphone 300 and the on-board apparatus 200 has become possible, the unlock signal is transmitted to the on-board apparatus 200. In this way, time required to perform unlocking in the vicinity of the vehicle can be shortened, and the necessity to operate the smartphone 300 in front of the eyes is reduced. In other words, it is possible to facilitate operations when unlocking the vehicle doors using a communication apparatus such as a smartphone.

### Second Embodiment

Next, a second embodiment will be described. The second embodiment describes processing that eliminates the need for a predetermined operation (e.g., shaking of a smartphone) when unlock reservation processing is repeatedly executed in a specific cyclic period. Note that, in the present embodiment, a vehicle 101 and a smartphone 300 are configured similarly to those according to the first embodiment, and a part of unlock reservation processing is different. Therefore, overlapping descriptions will be omitted by giving the same reference signs to the same constituents, and the following description will focus on the differences.

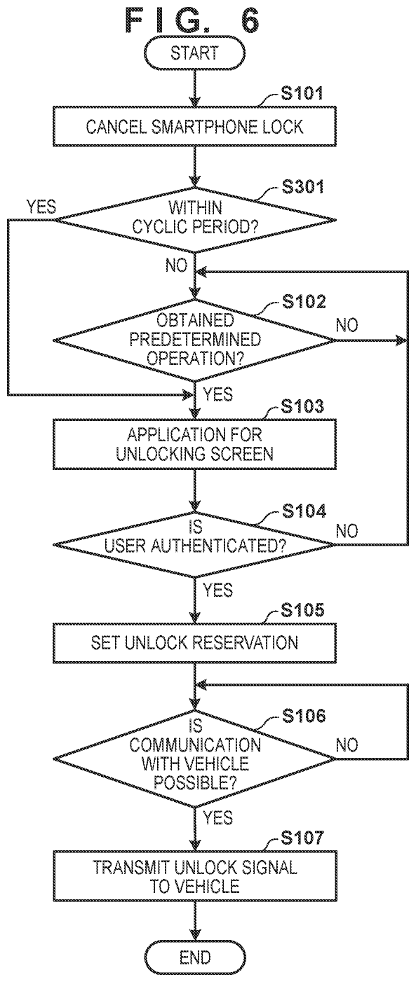

A description is now given of the unlock reservation processing according to the present embodiment with reference to FIG. 6. A flowchart shown in FIG. 6 is started in a state where an unlock reservation has already been set and the first unlocking of the vehicle has been performed similarly to the first embodiment. That is, FIG. 6 shows processing for making the second and subsequent unlock reservations. However, it will be assumed that, when the unlock application screen of step S103 is displayed, the operation obtaining unit 312 has obtained the cyclic period based on a user's operation.

In a case where the vehicle is used to commute on weekdays, it is assumed that, for example, a period from time that precedes time of boarding for the commute by a certain period and normal boarding time is set as the cyclic period. That is, in a case where the vehicle is boarded at 7:00 and 18:00 on weekdays, it is sufficient to set, for example, 6:30-7:00 and 17:30-18:00 of weekdays as the cyclic period. In this way, when the locked state of the smartphone is cancelled within the cyclic period, the unlock reservation application is enabled without performing the predetermined operation (e.g., shaking of the smartphone). The user can use an unlock reservation simply by performing user authentication only.

In step S101, the user authentication unit 314 of the control unit 302 authenticates a user and cancels the locked state of the smartphone 300 in response to, for example, contact that the user has made with the fingerprint sensor included in the sensor 304.

In step S301, the unlock reservation control unit 313 of the control unit 302 obtains the current time from a non-illustrated timer, and determines whether the current time is within the cyclic period. If the unlock reservation control unit 313 determines that the current time is within the cyclic period, it proceeds to step S103 to skip the acceptance of the predetermined operation. On the other hand, if the unlock reservation control unit 313 determines that the current time is not within the cyclic period, it proceeds to step S102 to obtain the predetermined operation similarly to the first embodiment. Thereafter, steps S102 to S107 are executed similarly to the first embodiment.

As described above, in the present embodiment, the cyclic period is obtained based on a user operation, and if the time of using the smartphone is within the cyclic period, the unlock application is enabled without obtaining the predetermined operation (e.g., shaking of the smartphone). In this way, in the case of repeated boarding, the vehicle doors can be unlocked with simpler operations.

### Summary of Embodiments

1. A storage medium according to an embodiment described above is a non-transitory computer readable storage medium storing a program for causing a computer to function as following units of a communication apparatus which includes a communication device (e.g., 301) that communicates with an on-board apparatus (e.g., 200) installed in a vehicle: an obtaining unit (e.g., 312) configured to obtain a predetermined operation performed by a user; and a control unit (e.g., 313) configured to control the communication device to transmit an unlock signal for unlocking a door of the vehicle to the on-board apparatus. When the predetermined operation is obtained before communication between the communication device and the on-board apparatus becomes possible, the control unit causes the communication device to transmit the unlock signal in response to an occurrence in which communication between the communication device and the on-board apparatus has become possible (e.g., steps S102, S106, S107).

According to this embodiment, as an instruction to perform unlocking can be set before communication between the smartphone 300 and the on-board apparatus 200 becomes possible, time required to perform unlocking in the vicinity of the vehicle can be shortened. For example, in bad weather such as heavy rain, boarding can be performed by quickly unlocking the door. Furthermore, as the necessity to operate the smartphone 300 in front of the eyes is reduced, the burden of operating the smartphone 300 in bad weather or when carrying a large amount of luggage, for example, can be lightened. That is, it is possible to facilitate operations when unlocking the door of the vehicle using the smartphone 300.

2. In the foregoing embodiment, the obtaining unit obtains an operation of applying predetermined vibration to the communication apparatus as the predetermined operation (e.g., step S102).

According to this embodiment, an operation can be performed without visually observing a display screen.

3. In the foregoing embodiment, the obtaining unit obtains an operation of changing an orientation of the communication apparatus in a predetermined manner as the predetermined operation (e.g., step S102).

According to this embodiment, an operation can be performed without visually observing a display screen.

4. In the foregoing embodiment, the communication apparatus further includes an enabling unit configured to, in response to obtainment of the predetermined operation, enable acceptance of a contact operation performed by the user to unlock the door of the vehicle (e.g., 315 and step S103).

According to this embodiment, the unlock reservation application can be activated and a user's operation with respect to this application can be smoothly obtained, thereby improving convenience.

5. In the foregoing embodiment, the obtaining unit further obtains a cyclic period from the user (step S301), and when time to use the communication apparatus is within the cyclic period, the enabling unit enables acceptance of the contact operation performed by the user to unlock the door of the vehicle, without obtaining the predetermined operation (steps S301, S103).

According to this embodiment, in the case of repeated boarding, the door of the vehicle can be unlocked with simpler operations.

6. In the foregoing embodiment, the control unit executes authentication for confirming validity of the user in response to obtainment of the predetermined operation (step S104), and when the user has been authenticated, transmits the unlock signal in response to an occurrence in which communication between the communication device and the on-board apparatus has become possible (step S107).

According to this embodiment, security can be enhanced by authenticating a user who makes an unlock reservation.

7. In the foregoing embodiment, when the predetermined operation is obtained again before a predetermined period elapses since locking of the vehicle, the control unit transmits the unlock signal without executing the authentication of the user.

According to this embodiment, when boarding and exiting the vehicle for a short period of time, unlocking can be performed with more simplified operations.

8. In the foregoing embodiment, the authentication of the user includes authentication using biometric authentication (304, 314).

According to this embodiment, the intensity of security of user authentication can be increased.

9. In the foregoing embodiment, the authentication of the user does not require the user to perform an operation on a display screen of the communication apparatus.

According to this embodiment, an operation can be performed without visually observing a display screen of the smartphone.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A non-transitory computer readable storage medium storing a program for causing a computer to function as following units of a communication apparatus which includes a communication device that communicates with an on-board apparatus installed in a vehicle:
an obtaining unit configured to obtain a predetermined operation performed by a user; and
a control unit configured to control the communication device to transmit an unlock signal for unlocking a door of the vehicle to the on-board apparatus,
wherein when the predetermined operation is obtained before communication between the communication device and the on-board apparatus becomes possible, the control unit causes the communication device to transmit the unlock signal in response to an occurrence in which communication between the communication device and the on-board apparatus has become possible.

2. The non-transitory computer readable storage medium according to claim 1,
wherein the obtaining unit obtains an operation of applying predetermined vibration to the communication apparatus as the predetermined operation.

3. The non-transitory computer readable storage medium according to claim 1,
wherein the obtaining unit obtains an operation of changing an orientation of the communication apparatus in a predetermined manner as the predetermined operation.

4. The non-transitory computer readable storage medium according to claim 1,
wherein the communication apparatus further includes an enabling unit configured to, in response to obtainment of the predetermined operation, enable acceptance of a contact operation performed by the user to unlock the door of the vehicle.

5. The non-transitory computer readable storage medium according to claim 4,
wherein the obtaining unit further obtains a cyclic period from the user, and
wherein when time to use the communication apparatus is within the cyclic period, the enabling unit enables acceptance of the contact operation performed by the user to unlock the door of the vehicle, without obtaining the predetermined operation.

6. The non-transitory computer readable storage medium according to claim 1,
wherein the control unit
executes authentication for confirming validity of the user in response to obtainment of the predetermined operation, and
when the user has been authenticated, transmits the unlock signal in response to an occurrence in which communication between the communication device and the on-board apparatus has become possible.

7. The non-transitory computer readable storage medium according to claim 6,
wherein when the predetermined operation is obtained again before a predetermined period elapses since locking of the vehicle, the control unit transmits the unlock signal without executing the authentication of the user.

8. The non-transitory computer readable storage medium according to claim 6,
wherein the authentication of the user includes authentication using biometric authentication.

9. The non-transitory computer readable storage medium according to claim 8,
wherein the authentication of the user does not require the user to perform an operation on a display screen of the communication apparatus.

10. A communication apparatus comprising:
a communication unit configured to communicate with an on-board apparatus installed in a vehicle;
an obtaining unit configured to obtain a predetermined operation performed by a user; and
a control unit configured to control the communication unit to transmit an unlock signal for unlocking a door of the vehicle to the on-board apparatus,
wherein when the predetermined operation is obtained before communication between the communication unit and the on-board apparatus becomes possible, the control unit causes the communication unit to transmit the unlock signal in response to an occurrence in which communication between the communication unit and the on-board apparatus has become possible.

11. A control method of a communication apparatus which includes a communication device that communicates with an on-board apparatus installed in a vehicle, the method comprising:
obtaining a predetermined operation performed by a user; and
controlling the communication device to transmit an unlock signal for unlocking a door of the vehicle to the on-board apparatus,
wherein when the predetermined operation is obtained before communication between the communication device and the on-board apparatus becomes possible, the controlling causes the communication device to transmit the unlock signal in response to an occurrence in which communication between the communication device and the on-board apparatus has become possible.

12. An unlock system comprising:
a communication apparatus; and
an on-board apparatus installed in a vehicle,
the communication apparatus including
a communication device configured to communicate with the on-board apparatus installed in the vehicle,
an obtaining unit configured to obtain a predetermined operation performed by a user, and
a control unit configured to control the communication device to transmit an unlock signal for unlocking a door of the vehicle to the on-board apparatus,
wherein when the predetermined operation is obtained before communication between the communication device and the on-board apparatus becomes possible, the control unit causes the communication device to transmit the unlock signal in response to an occurrence in which communication between the communication device and the on-board apparatus has become possible, and
wherein the on-board apparatus includes an unlock unit configured to unlock the door of the vehicle based on the unlock signal from the communication apparatus.
